(19) United States
(12) Patent Application Publication
(10) Pub. No.: US 2026/0205773 A1
(43) Pub. Date: Jul. 16, 2026

(54) WI-FI SCANNING FOR GEOFENCING AND SUB-LOCATION IDENTIFICATION AND RECOGNITION

(71) Applicant: Samsung Electronics Co., Ltd., Suwon-si (KR)

(72) Inventors: Rebal Al Jurdi, Allen, TX (US); Neha Dawar, McKinney, TX (US); Abhishek Sehgal, Frisco, TX (US); Yuming Zhu, Plano, TX (US); Junsu Choi, Suwon-si (KR)

(21) Appl. No.: 19/447,979

(22) Filed: Jan. 13, 2026

Related U.S. Application Data
(60) Provisional application No. 63/745,703, filed on Jan. 15, 2025.

(51) Int. Cl. H04W 4/029; H04W 4/02; H04W 4/021; H04W 48/16; H04W 52/02; H04W 88/02

(52) U.S. Cl. CPC H04W 4/029; H04W 4/021; H04W 4/023; H04W 48/16; H04W 52/0229; H04W 88/02

(57) ABSTRACT

Methods and apparatuses for Wi-Fi scanning that provides for geofencing and sub-location identification and recognition. A method performed by a device includes detecting whether an event has occurred for a device, wherein the event is based on a motion state of the device relative to a geofence. Further, the method includes identifying characteristics associated with the event, determining one or more times to schedule a scan request based on the characteristics associated with the event, scheduling the scan request at the one or more determined times, and performing the scan request scheduled at the one or more determined times.

### CROSS-REFERENCE TO RELATED AND CLAIM OF PRIORITY

The present application claims priority under 35 U.S.C. § 119(e) to U.S. Provisional Patent Application No. 63/745,703 filed on Jan. 15, 2025, which is hereby incorporated by reference in its entirety.

### TECHNICAL FIELD

The present disclosure relates generally to wireless communication systems and, more specifically, the present disclosure is related to methods and apparatuses for Wi-Fi scanning that provides for geofencing and sub-location identification and recognition.

### BACKGROUND

Location services are a key component of many modern applications, providing users with location-based information, experiences, and services, such as navigation, ride hailing, and weather forecasting. In providing such services, Wi-Fi scanning has become an integral part for accurately identifying a user's geographical and spatial location with an increased precision. However, to ensure location accuracy, Wi-Fi scanning must typically be performed on a frequent basis, which in turn consumes substantial amounts of computing, power, and network resources. Improved methods and apparatuses for Wi-Fi scanning are desirable.

### SUMMARY

The present disclosure relates to methods and apparatuses for Wi-Fi scanning that provides for geofencing and sub-location identification and recognition.

In one embodiment, a method performed by a device is provided. The method includes detecting whether an event has occurred for a device, wherein the event is based on a motion state of the device relative to a geofence. Further, the method includes identifying characteristics associated with the event, determining one or more times to schedule a scan request based on the characteristics associated with the event, scheduling the scan request at the one or more determined times, and performing the scan request scheduled at the one or more determined times.

In another embodiment, a device is provided. The device includes a transceiver and a processor operably coupled to the transceiver. The processor is configured to detect whether an event has occurred for the device, wherein the event is based on a motion state of the device relative to a geofence. Further the processor is configured to identify characteristics associated with the event, determine one or more times to schedule a scan request based on the characteristics associated with the event, schedule the scan request at the one or more determined times, and perform the scan request scheduled at the one or more determined times.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example circular geofence in relation to a point of interest (POI) according to embodiments of the present disclosure;

FIG. 2 illustrates an example communication system in accordance with an embodiment of this disclosure;

FIG. 3 illustrates an example electronic device in accordance with an embodiment of this disclosure;

FIG. 4 illustrates an example scan manager framed within the context of a location provider component of a device according to embodiments of the present disclosure;

FIG. 5 illustrates an example method performed by a scan manager of a device according to embodiments of the present disclosure;

FIG. 6 illustrates an example state machine that can be implemented by a scan manager of a device according to embodiments of the present disclosure;

FIG. 7 illustrates an example timing diagram associated with a state machine according to embodiments of the present disclosure;

FIG. 8 illustrates another example state machine that can be implemented by a scan manager of a device according to embodiments of the present disclosure;

FIG. 9 illustrates another example timing diagram associated with a state machine according to embodiments of the present disclosure;

FIG. 10 illustrates another example state machine that can be implemented by a scan manager of a device according to embodiments of the present disclosure;

FIG. 11 illustrates another example timing diagram associated with a state machine according to embodiments of the present disclosure;

FIG. 12 illustrates another example state machine that can be implemented by a scan manager of a device according to embodiments of the present disclosure;

FIGS. 13A and 13B illustrate example methods performed by a scan manager of a device according to embodiments of the present disclosure; and

FIG. 14 illustrates another example timing diagram associated with a state machine according to embodiments of the present disclosure.

### DETAILED DESCRIPTION

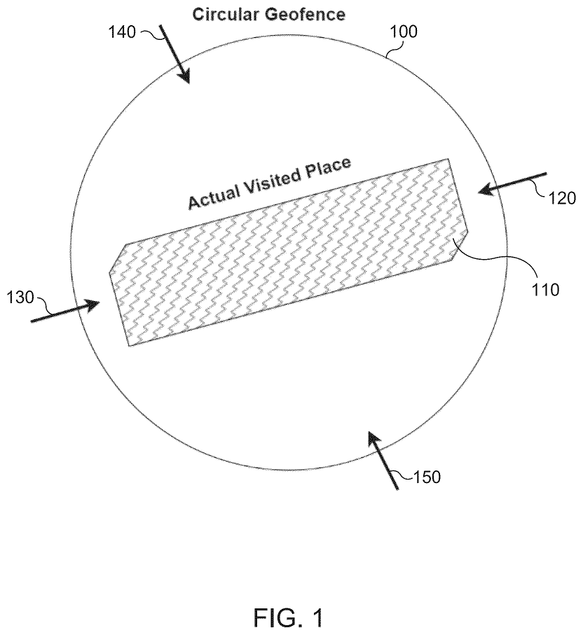

FIGS. 1-14 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

As introduced above, location services are a component of many modern applications, providing users with location-based information, experiences, and services, such as navigation, ride hailing, and weather forecasting. Location services encompass two domains: primary location, typically a geolocation, which refers to the broader, more general location of a device within a neighborhood or city, and sub-location, which refers to the narrower, more specific location of a device within the primary location such as a floor, zone, or room.

Sub-location can complement primary location by providing additional context through more precise and detailed information about a device's position within the primary location. For example, knowing that a device is at a specific zone or sub-location (e.g., a gate at an airport terminal) is more useful than just knowing the device is at the primary location (e.g., the airport terminal). This complementary information can be used to offer more targeted services, such as indoor navigation, proximity-based notifications, or location-based advertising.

While primary and geo-location can be determined by longer-range wireless technologies such as global navigation satellite systems (GNSS) and cellular networks, sub-location can be determined by shorter-range wireless technologies such as Wi-Fi, ultra-wide band (UWB), and Bluetooth.

One aspect of the present disclosure relates to geofencing. Geofencing is a location-based service that uses geolocation technologies, such as GNSS and cellular networks, to create a virtual boundary or “fence” around a specific geographic area of interest. This boundary can be used to trigger various actions or notifications when a device enters or exits the defined area.

Geofencing works in three steps. First, a geofence is created by defining a geometric shape, such as a circle, polygon, or rectangle, using latitude and longitude coordinates, and associating the geometric shape to a primary location. Second, triggers are set to define actions to be taken and notifications to be dispatch when a device enters or exits the geofence. Third, predefined actions and notifications are triggered when detecting the entry of the device into or exit of the device from geofence; this step is often referred to as geo-triggering.

Another aspect of the present disclosure relates to Wi-Fi. Due to the proliferation of Wi-Fi devices and infrastructure alike in all sorts of spaces (e.g., commercial and residential spaces, public and private spaces, indoors and outdoors spaces, etc.), and in numbers and densities far exceeding those supporting counterpart wireless technologies such as UWB and Bluetooth, Wi-Fi has become the de facto technology for enabling sub-location services, i.e., services providing sub-location, in the same way GNSS has long been the rooted and undisputed technology in enabling primary location services.

While a geofence has long been associated with a primary location such as a place of residence, work, or leisure that the user frequents, sub-location services, such as indoor positioning, have unlocked a different type of “fence,” namely one that is associated with a sub-location to define a smaller POI within the larger geofence. This different type of “fence” is often referred to as zone, sub-geofence, or micro-geofence. However, unlike a geofence, which typically has a well-defined geometric shape, a zone is typically defined through a joint distribution of received signal strengths (RSS) from different Wi-Fi devices, specifically access points (APs), and thus may take a lot of care and effort to define.

To alleviate the user's burden of defining zones, as is usually the case with defining geofences, clustering techniques can be used, often involving algorithms of unsupervised learning techniques to automatically discover and define zones frequented by the user.

Yet another aspect of the present disclosure, as introduced above, is Wi-Fi scanning. All sub-geofencing techniques rely on a crucial process: frequently sampling the power received from neighboring APs and other relevant information, also known as Wi-Fi scanning. Wi-Fi scanning is also used in the stage following the definition of zones or model training, namely in the inference stage, i.e., identifying the zone the user is present in.

There are two main types of Wi-Fi scans: active scans and passive scans. An active scan involves the device transmitting a probe request frame to nearby Wi-Fi networks and waiting for a probe response frame. This type of scan is typically used when a device is trying to connect to a specific network. A passive scan involves the device listening for beacon frames transmitted by nearby Wi-Fi networks without transmitting any requests. This type of scan is typically used when a device is trying to detect nearby networks without connecting to them. While active scans provide more information and faster scan times, they consume more power and contribute to network congestion. Passive scans, on the other hand, consume less power and contribute less to network congestion, but may take longer to complete and provide less information.

The scan time and power consumption can be reduced by scanning a subset of the available Wi-Fi channels through what is known as a partial scan, while still providing information about nearby Wi-Fi networks and most importantly measure the received power from neighboring APs. The partial scan, like a full scan, can be either active or passive. In an active scan, the Wi-Fi adapter hops from one channel to another in a limited set, listening for beacon frames transmitted by nearby APs. In a passive scan, the adapter sends probe requests to the set of channels.

Despite the benefits of partial scans, they are not as widely adopted as full scans, due to both hardware and software limitations as well as security concerns.

Yet another aspect of the present disclosure is geofence refinement. While GNSS is the bedrock of geofencing and geo-triggering, Wi-Fi is the bedrock of sub-geofencing and sub-geo-triggering. As discussed above, Wi-Fi measurements can be crucial for mining and identifying frequently visited zones, however, Wi-Fi measurements can also be used to refine the definition of an encompassing geofence.

FIG. 1 illustrates an example circular geofence 100 in relation to a POI 110 according to embodiments of the present disclosure. In particular, FIG. 1 illustrates POI 110 disposed within circular geofence 100 such that significant distances or gaps exist between the boundary of POI 110 and circular geofence 100, particularly to the North and South of POI 110. This example is for illustration only and other embodiments can be used without departing from the scope of the present disclosure.

As illustrated in FIG. 1, a user may set circular geofence 100 around POI 110 (i.e., the “actually-visited” area). In this example, POI 110 has the shape of a thin rectangle and an East-West orientation. As such, entering circular geofence 100 from either the East entrance 120 or the West entrance 130 puts the user very close to the boundaries of POI 110. However, entering circular geofence 100 from either the North entrance 130 or the South entrance 140 keeps the user quite far from the actual boundaries of POI 110 which can cause actions to be triggered and notifications to be sent too soon. Further, leaving circular geofence 100 leads to the opposite problem. Leaving the geofence from either the North entrance 130 or the South entrance 140 can cause actions to be triggered and notifications to be sent too late in relation to exiting POI 110. For purposes of the present disclosure, these two problems will be jointly referred to as the geo-triggering problem.

In order to resolve this geo-triggering problem, a thin, rectangular geofence in the orientation of that of POI 110 could be implemented and clearly be a better alternative to circular geofence 100 circumscribing POI 110. However, defining a geofence in this way can be challenging for various reasons, including: the POI does not conform to a standard geometric shape, the set of supported geofences may be limited to only the most basic geometrical shapes, and the mathematical definition of such a geofence may be difficult to obtain, e.g. the geolocations of the vertices of a polygonal geofence may be elusive.

As an alternative to defining a single geofence with a non-standard geometric shape, a combination of a geofence and sub-geofences therein may be utilized, as is the case in the present disclosure, with the sub-geofences being defined relative to Wi-Fi APs, or more abstractly, as a function of the received signal strength from a set of Wi-Fi APs of unknown locations. The details of this alternative are beyond the scope of this disclosure.

When a combination of a geofence and sub-geofences therein are utilized, Wi-Fi scanning is the bedrock of sub-geofencing, or zone identification, sub-geo-triggering, or zone recognition, and geofence refinement and assisted geo-triggering. To ensure accurate sub-geofencing and geofence refinement and responsive geo-triggering and sub-geotriggering, Wi-Fi scanning needs to be performed frequently. However, Wi-Fi scanning, as set forth above, consumes substantial amounts of computing, power, and network resources, particularly with regard to active scans.

The present disclosure provides methods and apparatuses for determining a Wi-Fi scan schedule on a device based on the identified geofence the device is present in and the state of motion of the device. As will be described in greater detail below, the methods and apparatuses provide for the configuring of a scan manager to schedule a next scan request in response to a change in a geofence and subsequently in response to a change in a motion state associated with the user (e.g., the user's device) within the geofence. Further, the methods and apparatuses provide for the configuring of the scan manager to determine a rate of scan requests and matching criteria based on an algorithm that monitors a change in a geofence and subsequently a change in a motion state associated with the user (e.g., user's device) within the geofence. This may include requesting partial scans (i.e. of a subset of frequency bands and/or channels therein) in addition to full scans (i.e. of all frequency bands and channels therein) at a rate based on the motion state associated with the user and whether they are at a point of interest. Further, this may include selecting the Wi-Fi channels frequency bands and channels to scan according to an algorithm that trades off the number of access points scanned with power consumption and the time it takes to complete the scan.

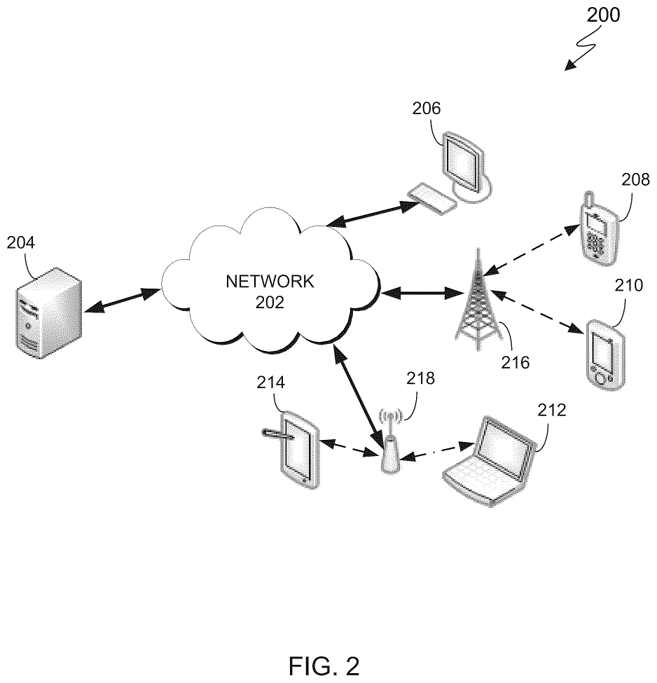

FIG. 2 illustrates an example communication system 200 in accordance with an embodiment of this disclosure. The embodiment of the communication system 200 shown in FIG. 2 is for illustration only. Other embodiments of the communication system 200 can be used without departing from the scope of this disclosure.

The communication system 200 includes a network 202 that facilitates communication between various components in the communication system 200. For example, the network 202 can communicate IP packets, frame relay frames, Asynchronous Transfer Mode (ATM) cells, or other information between network addresses. The network 202 includes one or more local area networks (LANs), metropolitan area networks (MANs), wide area networks (WANs), all or a portion of a global network such as the Internet, or any other communication system or systems at one or more locations.

In this example, the network 202 facilitates communications between a server 204 and various client devices 206-214. The client devices 206-214 may be, for example, a smartphone (such as a UE), a tablet computer, a laptop, a personal computer, a wearable device, a head mounted display, or the like. The server 204 can represent one or more servers. Each server 204 includes any suitable computing or processing device that can provide computing services for one or more client devices, such as the client devices 206-214. Each server 204 could, for example, include one or more processing devices, one or more memories storing instructions and data, and one or more network interfaces facilitating communication over the network 202.

Each of the client devices 206-214 represent any suitable computing or processing device that interacts with at least one server (such as the server 204) or other computing device(s) over the network 202. The client devices 206-214 include a desktop computer 206, a mobile telephone or mobile device 208 (such as a smartphone), a PDA 210, a laptop computer 212, and a tablet computer 214. However, any other or additional client devices could be used in the communication system 200, such as wearable devices. Smartphones represent a class of mobile devices 208 that are handheld devices with mobile operating systems and integrated mobile broadband cellular network connections for voice, short message service (SMS), and Internet data communications. In certain embodiments, any of the client devices 206-214 can perform processes for determining UWB beacon locations for service areas for a location based service.

In this example, some client devices 208-214 communicate indirectly with the network 202. For example, the mobile device 208 and PDA 210 communicate via one or more base stations 216, such as cellular base stations or eNodeBs (eNBs) or gNodeBs (gNBs). Also, the laptop computer 212 and the tablet computer 214 communicate via one or more wireless APs 218, such as IEEE 802.11 wireless APs. Note that these are for illustration only and that each of the client devices 206-214 could communicate directly with the network 202 or indirectly with the network 202 via any suitable intermediate device(s) or network(s). In certain embodiments, any of the client devices 206-214 transmit information securely and efficiently to another device, such as, for example, the server 204.

As described in more detail below, one or more of the network 202, server 204, and client devices 206-214 include circuitry, programing, or a combination thereof, to support Wi-Fi scanning that provides for accurate and responsive geofencing and sub-location identification and recognition.

Although FIG. 2 illustrates one example of a communication system 200, various changes can be made to FIG. 2. For example, the communication system 200 could include any number of each component in any suitable arrangement. In general, computing and communication systems come in a wide variety of configurations, and FIG. 2 does not limit the scope of this disclosure to any particular configuration. While FIG. 2 illustrates one operational environment in which various features disclosed in this patent document can be used, these features could be used in any other suitable system.

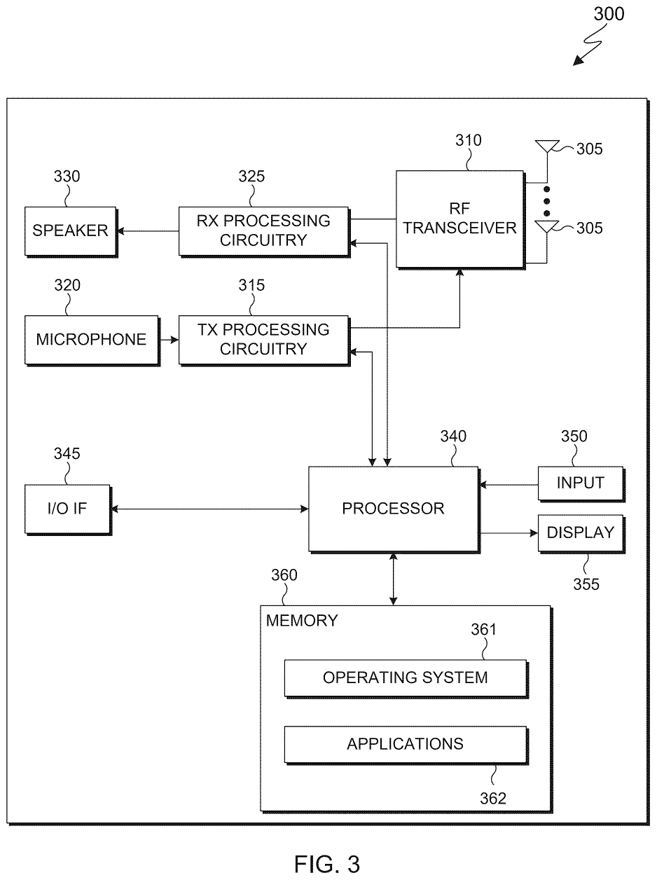

FIG. 3 illustrates an example electronic device in accordance with an embodiment of this disclosure. In particular, FIG. 3 illustrates an example electronic device 300, and the electronic device 300 could represent the server 204 or one or more of the client devices 206-214 in FIG. 2. The electronic device 300 can be a mobile communication device, such as, for example, a UE, a mobile station, a subscriber station, a wireless terminal, a desktop computer (similar to the desktop computer 206 of FIG. 2), a portable electronic device (similar to the mobile device 208, the PDA 210, the laptop computer 212, or the tablet computer 214 of FIG. 2), a robot, and the like.

As shown in FIG. 3, the electronic device 300 includes transceiver(s) 310, transmit (TX) processing circuitry 315, a microphone 320, and receive (RX) processing circuitry 325. The transceiver(s) 310 can include, for example, a RF transceiver, a Bluetooth transceiver, a Wi-Fi transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor 365. The memory 360 includes an operating system (OS) 361, and one or more applications 362.

The transceiver(s) 310 can include an antenna array including numerous antennas. For example, the transceiver(s) 310 can be equipped with multiple antenna elements. There can also be one or more antenna modules fitted on the terminal where each module can have one or more antenna elements. The antennas of the antenna array can include a radiating element composed of a conductive material or a conductive pattern formed in or on a substrate. The transceiver(s) 310 transmit and receive a signal or power to or from the electronic device 300. The transceiver(s) 310 receives an incoming signal transmitted from an access point (such as a base station, Wi-Fi router, or Bluetooth device) or other device of the network 202 (such as a Wi-Fi, Bluetooth, cellular, 5G, LTE, LTE-A, WiMAX, or any other type of wireless network). The transceiver(s) 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The transceiver(s) 310 receives the outgoing processed baseband or intermediate frequency signal from the TX processing circuitry 315 and up-converts the baseband or intermediate frequency signal to a signal that is transmitted.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the transceiver(s) 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry. In certain embodiments, the processor 340 can include a neural network.

The processor 340 is also capable of executing other processes and programs resident in the memory 360, such as operations that receive and store data, and for example, processes that support Wi-Fi scanning that provides for accurate and responsive geofencing and sub-location identification and recognition. The processor 340 can move data into or out of the memory 360 as required by an executing process. In certain embodiments, the processor 340 is configured to execute the one or more applications 362 based on the OS 361 or in response to signals received from external source(s) or an operator. For example, applications 362 can include a multimedia player (such as a music player or a video player), a phone calling application, a virtual personal assistant, and the like.

The processor 340 is also coupled to the I/O interface 345 that provides the electronic device 300 with the ability to connect to other devices, such as client devices 206-214. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user to interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365, a camera, and the like, which provide additional inputs to the processor 340. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be a singular display screen or multiple display screens capable of creating a stereoscopic display. In certain embodiments, the display 355 is a heads-up display (HUD).

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, optical sensors, cameras, one or more inertial measurement units (IMUs), such as a gyroscope or gyro sensor, and an accelerometer. The sensor 365 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein. Any of these sensor(s) 365 may be located within the electronic device 300 or within a secondary device operably connected to the electronic device 300.

Although FIG. 3 illustrates one example of electronic device 300, various changes can be made to FIG. 3. For example, various components in FIG. 3 can be combined, further subdivided, or omitted and additional components can be added according to particular needs. As a particular example, the processor 340 can be divided into multiple processors, such as one or more central processing units (CPUs), one or more graphics processing units (GPUs), one or more neural networks, and the like. Also, while FIG. 3 illustrates the electronic device 300 configured as a mobile telephone, tablet, or smartphone, the electronic device 300 can be configured to operate as other types of mobile or stationary devices.

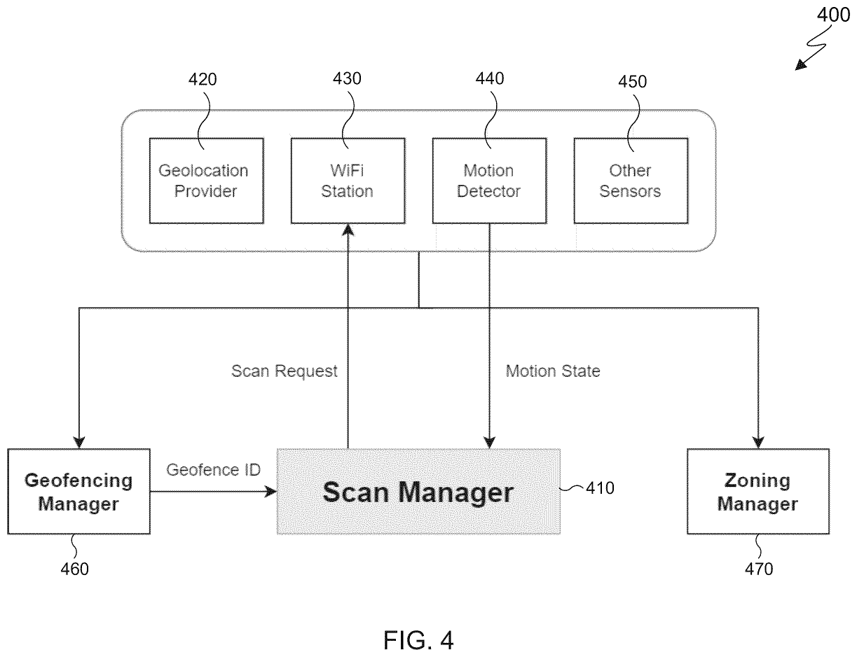

FIG. 4 illustrates an example scan manager 410 framed within the context of a location provider component 400 of a device according to embodiments of the present disclosure. For example, location provider component 400 may be implemented in electronic device 300 of FIG. 3. This example is for illustration only and other embodiments can be used without departing from the scope of the present disclosure.

In various embodiments, scan manager 410 is a module that issues requests to scan for nearby Wi-Fi devices and networks that optionally meet special criteria such as operating on a particular frequency band or channel. Scan manager 410 determines the rate of scan requests and the matching criteria for the nearby devices and networks through an algorithm that monitors the identified geofence, motion state, and other inputs.

As set forth above, scan manager 410 is framed within the context of location provider component 400 which is configured to provide a composite location made of a primary location and a secondary location. The primary location is represented by a geofence identifier, or geofence ID or GID, and the secondary location is represented by a zone identifier, or zone ID or ZID. For example, the composite location can be Home-Bedroom, Office-Breakroom, or Gym-Pool.

As illustrated in FIG. 4, location provider component 400 may comprise, in addition to scan manager 410, a geolocation provider 420, a Wi-Fi station 430, motion detector 440, and other sensors 450. Geolocation provider 420 is configured to provide device geolocation, which includes the latitude, longitude, and altitude, and which can be derived from global positioning system (GPS) measurements, provided by the cellular network, Wi-Fi network, or other sources. Wi-Fi station 430 is configured to communicate with and measure strength of Wi-Fi signals received from other Wi-Fi devices, including APs. Motion detector 440 is configured to detect motion, or the absence of thereof, using the device's IMU or other system of sensors. Other sensors 450 include environment sensors and other wireless receivers.

Location provider component 400 may further comprise a geofence manager 460 and a zone manager 470. Geofence manager 460 is configured to perform two main functions: geofencing and geo-triggering. Geofencing refers to the identification (and definition) of geofences directly through user input, or indirectly through the discovery of primary locations that are visited or frequently visited by the user, mainly from geolocation measurements, but not exclusively. Geo-triggering refers to the triggering of actions based on events of entry into and exit from defined geofences, and, as a result, the recognition of the primary location that the geofence is associated with, if there is one. Additionally, geofence manager 460 is configured to provide information about the quality of prediction and other information. Zone manager 470 is configured to perform two main functions: zoning and zone triggering. In the present disclosure, zoning is used to refer to the identification (and definition) of zones, inside a geofence, directly through user input, or indirectly through the discovery of zones that are visited or frequently visited by the user, mainly from Wi-Fi measurements, but not exclusively. Zone triggering refers to the triggering of actions based on the events of entry to and exit from defined zones, and, as a result, the recognition of the zone that the device is presently in, if one exists. Additionally, zone manager 470 is configured to provide information about the quality of prediction and other information.

With the above location and motion state information, scan manager 410 effectively issue scan requests in response to certain events, select scan intervals, and determine a scan schedule.

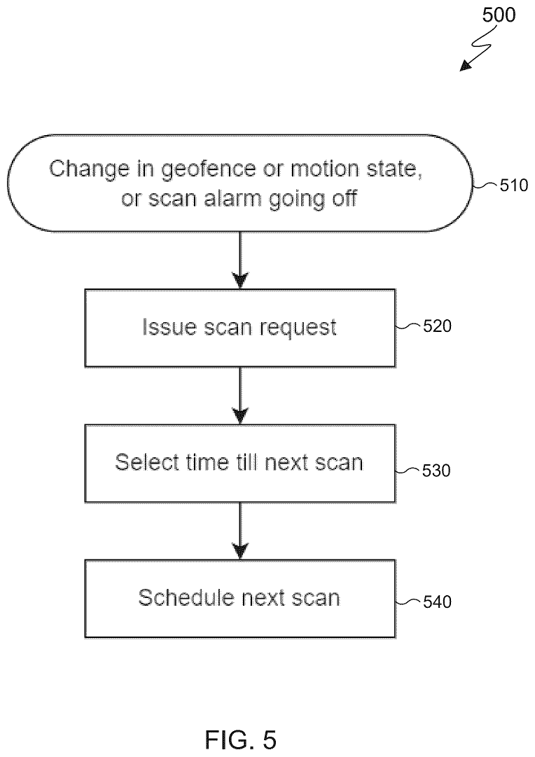

FIG. 5 illustrates an example method 500 performed by a scan manager of a device according to embodiments of the present disclosure. For example, method 500 can be performed by scan manager 410 of FIG. 4 upon detecting a change in geofence or motion state of the device, or a scan alarm going off. The scan alarm indicates when it is time to issue a scan request (e.g., a scan request that was previously scheduled). The method 500 is for illustration only and other embodiments can be used without departing from the scope of the present disclosure.

At a high level, as illustrated in FIG. 5, upon detecting a change in geofence or motion state of the device, or the scan alarm going off, or other events (510), method 500 performs the following steps:
Step 520: issues a scan quest to the Wi-Fi station.
Step 530: selects a time until the next or subsequent scan request, or alternatively selects a scan interval at which to issue periodic scan requests.
Step 540: schedules the next or subsequent scan request, or determines a scan schedule based on the selected scan interval.
   For purposes of the present disclosure, the action of selecting a time until the next or subsequent scan request and scheduling the next scan request is referred to as setting a scan alarm.

In various embodiment, scan manager 410 may use a state machine to determine a scan schedule in response to a change in geofence, a change in motion state, or a scan alarm going off.

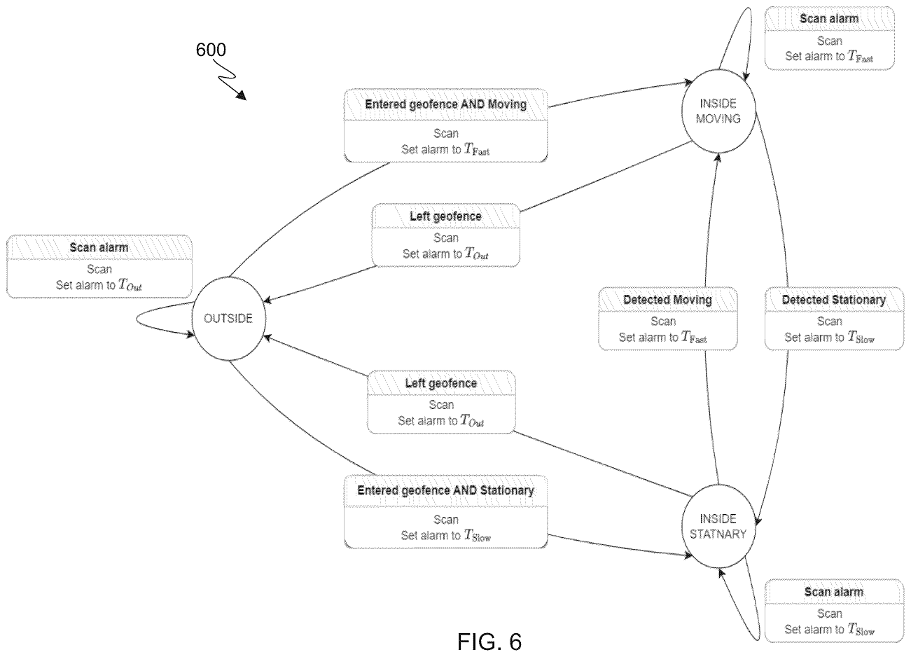

FIG. 6 illustrates an example state machine 600 that can be implemented by a scan manager of a device according to embodiments of the present disclosure. For example, state machine 600 can be implemented by scan manager 410 of FIG. 4. This example is for illustration only and other embodiments can be used without departing from the scope of the present disclosure.

As illustrated in FIG. 6, state machine 600 has the following states:
Outside: Scan interval is T_{Out}
Stationary, short for Inside-Stationary: Scan interval is T_{Slow}<T_{Out}
Moving, short for Inside-Moving: Scan interval is T_{Fast}<T_{Slow}

Furthermore, state machine 600 adheres to the following transition conditions and actions:
From Outside:
   To Outside: When scan alarm goes off, issue scan request, and set alarm after T_{Out}
   To Moving: When device enters geofence and is moving, issue scan request, and set alarm after T_{Fast}
   To Stationary: When device enters geofence and is stationary, issue scan request, and set alarm after T_{Slow}
From Moving:
   To Moving: When scan alarm goes off, issue scan request, and set alarm after T_{Fast}
   To Stationary: When motion state changes to stationary, issue scan request, and set alarm after T_{Slow}
   To Outside: When device exits geofence, issue scan request, and set alarm after T_{Out}
From Stationary:
   To Stationary: When scan alarm goes off, issue scan request, and set alarm after T_{Slow}
   To Moving: When motion state changes to moving, issue scan request, and set alarm after T_{Fast}
   To Outside: When device exits geofence, issue scan request, and set alarm after T_{Out}

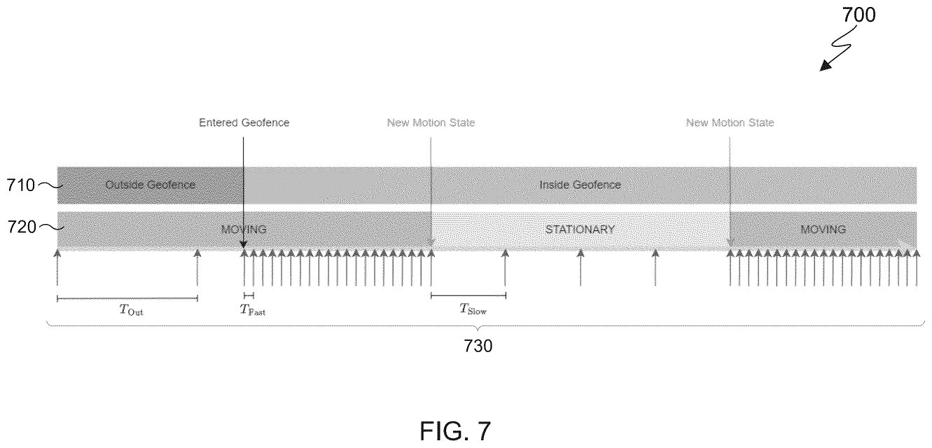

FIG. 7 illustrates an example timing diagram 700 associated with a state machine according to embodiments of the present disclosure. More particularly, timing diagram 700 illustrates an example scan schedule determined under state machine 600 in response to changes in the state of motion of the device and the entering of the device into a geofence. This example is for illustration only and other embodiments can be used without departing from the scope of the present disclosure.

As illustrated in FIG. 7, timing diagram 700 may comprise an upper block 710 and a lower block 720, where upper block 710 represents the time frame in which the device is outside or inside the geofence and lower block 720 represents the time frame in which the device is moving or stationary. Furthermore, arrows 730 may represent the scan requests issued/scheduled by the device, with the spaces between the arrows representing the various scan intervals.

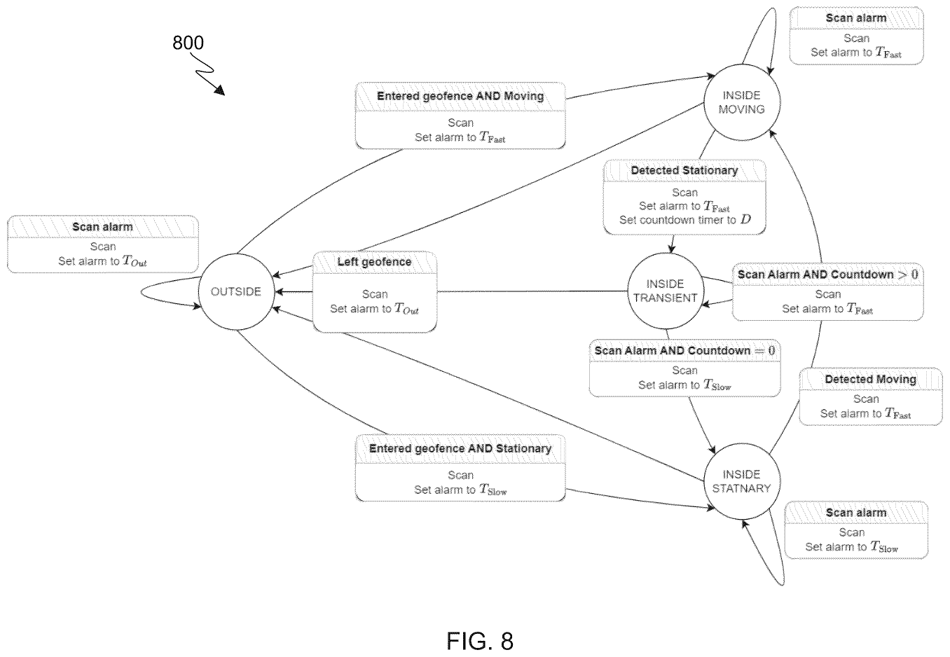

FIG. 8 illustrates an example state machine 800 that can be implemented by a scan manager of a device according to embodiments of the present disclosure. For example, state machine 800 can be implemented by scan manager 410 of FIG. 4. This example is for illustration only and other embodiments can be used without departing from the scope of the present disclosure.

As illustrated in FIG. 8, state machine 800 has the following states:
Outside: Scan interval is T_{Out}
Stationary, short for Inside-Stationary: Scan interval is T_{Slow}<T_{Out}
Moving, short for Inside-Moving: Scan interval is T_{Fast}<T_{Slow}
Transient, short for Inside-Transient: “Layover” state when going from Moving to Stationary where Scan interval remains T_{Fast}

Furthermore, state machine 800 adheres to the following transition conditions and actions:
From Outside:
   To Outside: When scan alarm goes off, issue scan request, and set alarm after T_{Out}
   To Moving: When device enters geofence and is moving, issue scan request, and set alarm after T_{Fast}
   To Stationary: When device enters geofence and is stationary, issue scan request, and set alarm after T_{Slow}
From Moving:
   To Moving: When scan alarm goes off, issue scan request, and set alarm after T_{Fast}
   To Transient: When motion state changes to stationary, issue scan request, set alarm after T_{Fast}, and set countdown timer to D; alternatively, a counter that decrements on every scan request can be set
   To Outside: When device exits geofence, issue scan request, and set alarm after T_{Out}
From Transient:
   To Transient: When scan alarm goes off and has not yet counted down to 0, issue scan request, and set alarm after T_{Fast}
   To Stationary: When scan alarm goes off and has counted down to 0, issue scan request, and set alarm after T_{Slow}
   To Outside: When device exits geofence, issue scan request, and set alarm after T_{Out}
From Stationary:
   To Stationary: When scan alarm goes off, issue scan request, and set alarm after T_{Slow}
   To Moving: When motion state changes to moving, issue scan request, and set alarm after T_{Fast}
   To Outside: When device exits geofence, issue scan request, and set alarm after T_{Out}

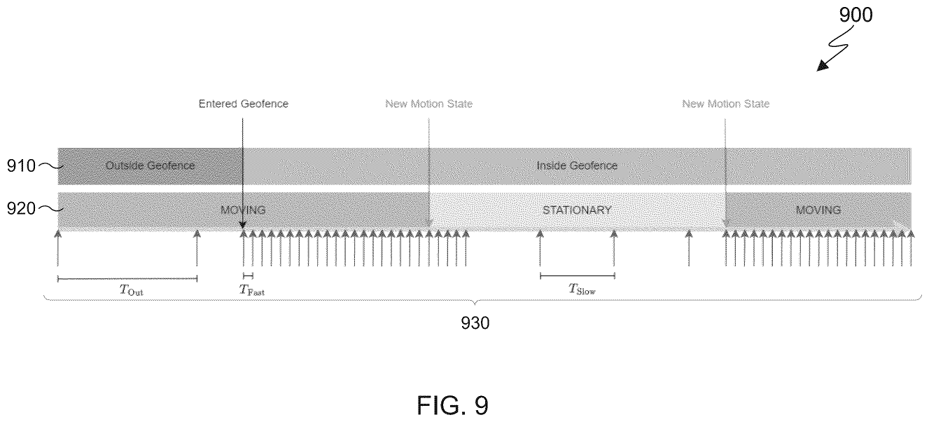

FIG. 9 illustrates an example timing diagram 900 associated with a state machine according to embodiments of the present disclosure. More particularly, timing diagram 900 illustrates an example scan schedule determined under state machine 800 in response to changes in the state of motion of the device and the entering of the device into a geofence. This example is for illustration only and other embodiments can be used without departing from the scope of the present disclosure.

As illustrated in FIG. 9, timing diagram 900 may comprise an upper block 910 and a lower block 920, where upper block 910 represents the time frame in which the device is outside or inside the geofence and lower block 920 represents the time frame in which the device is moving or stationary. Furthermore, arrows 930 may represent the scan requests issued/scheduled by the device, with the spaces between the arrows representing the various scan intervals.

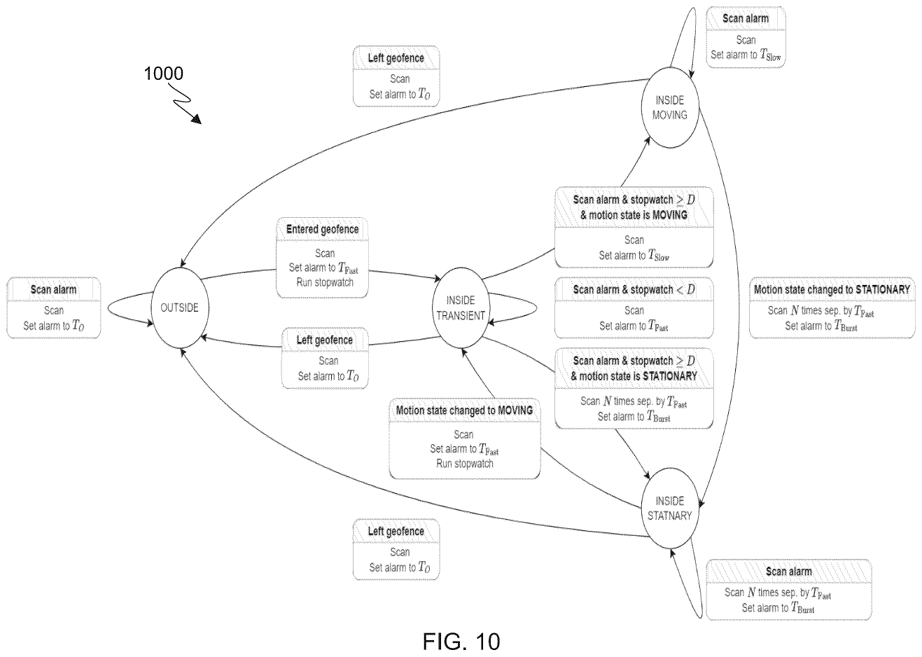

FIG. 10 illustrates an example state machine 1000 that can be implemented by a scan manager of a device according to embodiments of the present disclosure. For example, state machine 1000 can be implemented by scan manager 410 of FIG. 4. This example is for illustration only and other embodiments can be used without departing from the scope of the present disclosure.

As illustrated in FIG. 10, state machine 1000 has the following states:
Outside: Scan interval is T_{Out}
Stationary, short for Inside-Stationary: Issues a burst request of N scans at a burst scan interval of T_{Burst}≤T_{Out}
Moving, short for Inside-Moving: Scan interval is T_{Slow}<T_{Burst}
Transient, short for Inside-Transient: “Layover” state when going from Outside to Moving or Stationary and from Stationary to Moving, where scan interval is T_{Fast}<T_{Slow}

Furthermore, state machine 1000 adheres to the following transition conditions and actions:
From Outside:
   To Outside: When scan alarm goes off, issue scan request, and set alarm after T_{Out}
   To Transient: When device enters geofence, issue scan request, set alarm after T_{Fast}, and run stopwatch
From Moving:
   To Moving: When scan alarm goes off, issue scan request, and set alarm after T_{Slow}
   To Stationary: When motion state changes to stationary, issue N scan requests separated by T_{Fast}, and set alarm after T_{Burst}
   To Outside: When device exits geofence, issue scan request, and set alarm after T_{Out}
From Transient:
   To Transient: When scan alarm goes off and stopwatch<D, issue scan request, and set alarm after T_{Fast}
      To Moving: When scan alarm goes off, stopwatch≥D, and devices is moving, issue scan request, and set alarm after T_{Slow}
      To Stationary: When scan alarm goes off, stopwatch≥D, and devices is moving, issue N scan requests separated by T_{Fast}, and set alarm after T_{Burst}
      To Outside: When device exits geofence, issue scan request, and set alarm after T_{Out}
From Stationary:
   To Stationary: When scan alarm goes off, issue N scan requests separated by T_{Fast}, and set alarm after T_{Burst}
   To Transient: When motion state changes to moving, issue scan request, set alarm after T_{Fast}, and run stopwatch
   To Outside: When device exits geofence, issue scan request, and set alarm after T_{Out}

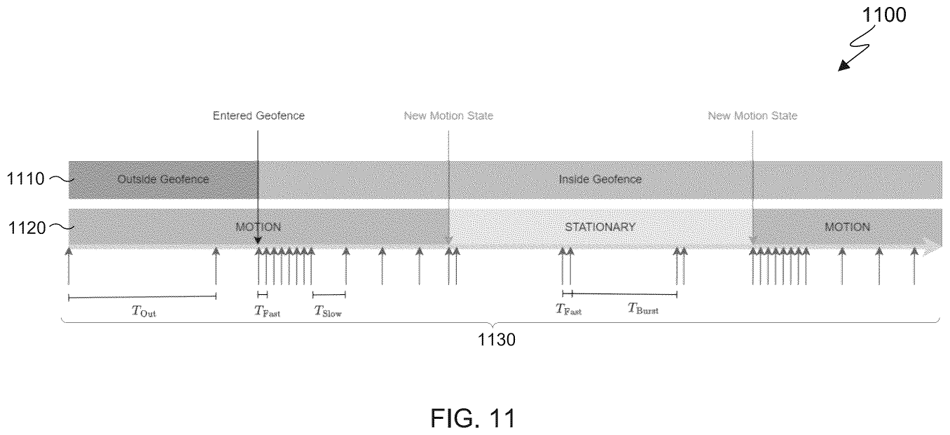

FIG. 11 illustrates an example timing diagram 1100 associated with a state machine according to embodiments of the present disclosure. More particularly, timing diagram 1100 illustrates an example scan schedule determined under state machine 1000 in response to changes in the state of motion of the device and the entering of the device into a geofence. This example is for illustration only and other embodiments can be used without departing from the scope of the present disclosure.

As illustrated in FIG. 11, timing diagram 1100 may comprise an upper block 1110 and a lower block 1120, where upper block 1110 represents the time frame in which the device is outside or inside the geofence and lower block 1120 represents the time frame in which the device is moving or stationary. Furthermore, arrows 1130 may represent the scan requests issued/scheduled by the device, with the spaces between the arrows representing the various scan intervals.

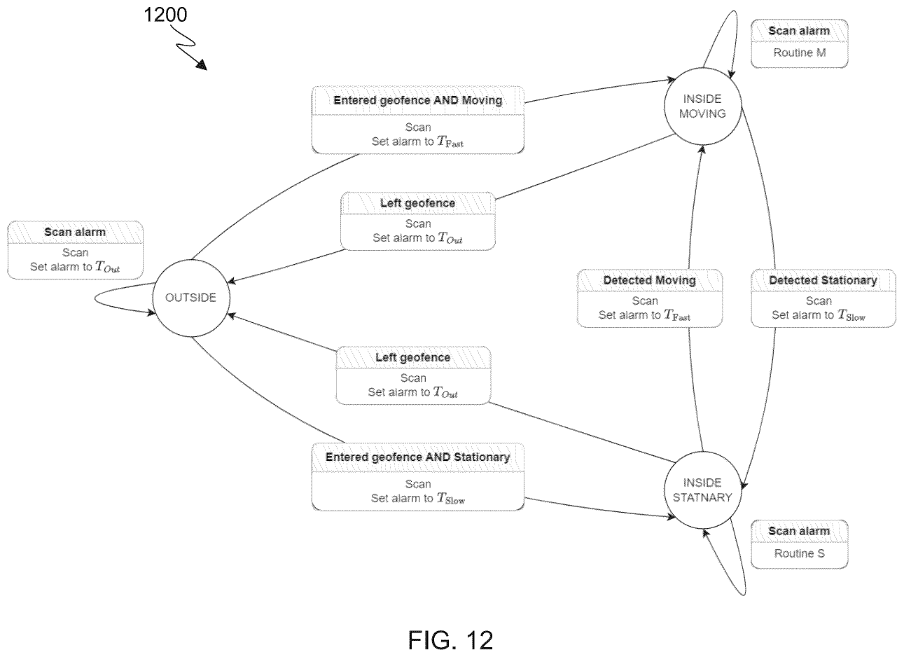

FIG. 12 illustrates an example state machine 1200 that can be implemented by a scan manager of a device according to embodiments of the present disclosure. For example, state machine 1200 can be implemented by scan manager 410 of FIG. 4. This example is for illustration only and other embodiments can be used without departing from the scope of the present disclosure.

As illustrated in FIG. 12, state machine 1200 has the following states:
Outside: Full scan interval, i.e. interval for request for full scan is T_{Out}
Moving, short for Inside-Moving: Scan interval is T_{Fast}<T_{Slow} and partial scan interval, i.e. interval for request for partial scan, is T_{P}_{₁}<T_{Fast}
Stationary, short for Inside-Stationary: Full Scan interval is T_{Slow}<T_{Out} and partial scan interval is T_{P}_{₁}<T_{P}_{₂}<T_{Slow}

Furthermore, state machine 1200 adheres to the following transition conditions and actions:
From Outside:
   To Outside: When scan alarm goes off, issue scan request, and set alarm after T_{Out}
   To Moving: When device enters geofence and is moving, issue scan request, and set alarm after T_{Fast}
   To Stationary: When device enters geofence and is stationary, issue scan request, and set alarm after T_{Slow}
From Moving:
   To Moving: When scan alarm goes off, execute Routine M described below
   To Stationary: When motion state changes to stationary, issue scan request, and set alarm after T_{Slow}
   To Outside: When device exits geofence, issue scan request, and set alarm after T_{Out}
From Stationary:
   To Stationary: When scan alarm goes off, execute Routine S described below
   To Moving: When motion state changes to moving, issue scan request, and set alarm after T_{Fast}
   To Outside: When device exits geofence, issue scan request, and set alarm after T_{Out}

In various embodiments, Routine M is the process and decisions taken by scan manager 410 when the scan alarm goes off and the device is moving inside the geofence. Similarly, Routine S is the process and decisions taken by scan manager 410 when the scan alarm goes off, but the device is stationary inside the geofence. Before either routine is executed, and for every geofence, scan manager 410 may create a dictionary having keys associated with Wi-Fi channels and values associated with lists of basic service set identifiers (BSSIDs) operating at the corresponding channel.

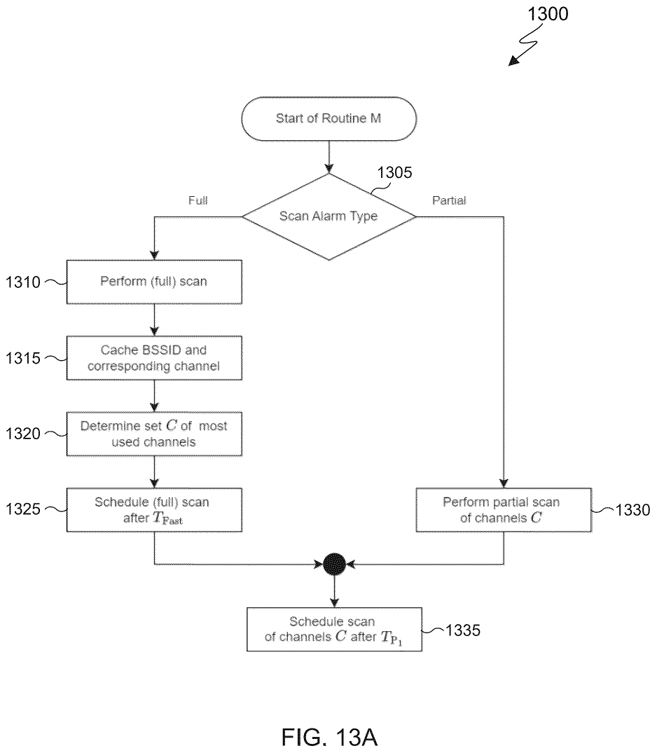

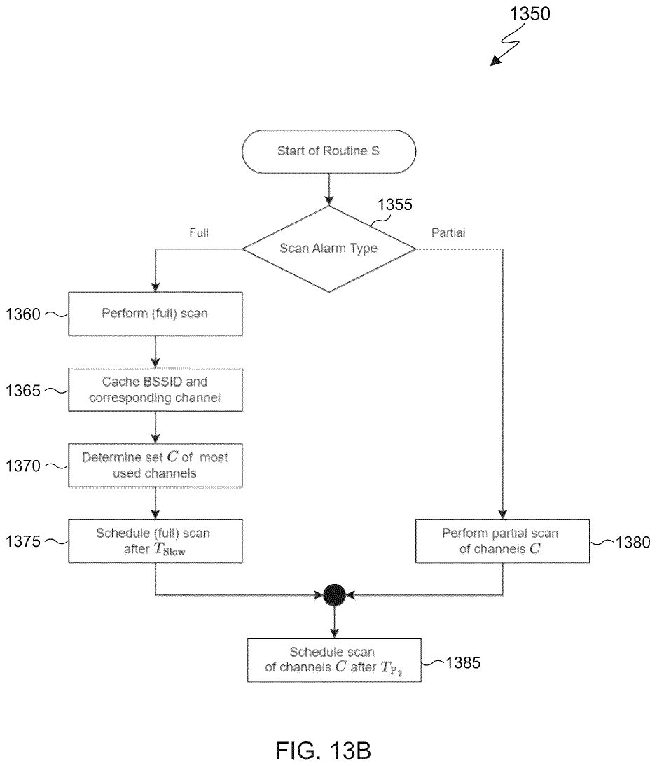

FIG. 13A illustrates an example method 1300 for Routine M according to embodiments of the present disclosure. FIG. 13B illustrates an example method 1350 for Routine S according to embodiments of the present disclosure. For example, methods 1300 and 1350 can be implemented by scan manager 410 of FIG. 4. These examples are for illustration only and other embodiments can be used without departing from the scope of the present disclosure.

As illustrated in FIG. 13A, method 1300 may comprise the following operations, starting at Step 1305:
Step 1305: Determine if the scan alarm corresponds to a full scan or to a partial scan; in the case of a full scan alarm proceed to Step 1310; otherwise, proceed to Step 1330
Step 1310: Issue request for full scan and wait to receive scan results
Step 1315: Add every BSSID appearing in the scan results into the set Bᵢ that matches corresponding channel cᵢ
Step 1320: Determines the set C of most used channels as follows:
   Compute the coverage {rᵢ} of every channel i, i.e., the ratio of BSSIDs operating on channel i to all BSSIDs, as a function of the sizes of the BSSID sets {|Bⱼ|} for every channel j. This is represented by the equation below:

$${r}_{i} = \frac{\vert {B}_{i} \vert}{{\sum }_{j} \vert {B}_{j} \vert}$$

Sort the dictionary, i.e., channel-coverage pairs {(cᵢ, brᵢ)} in decreasing order of coverage, yielding (cᵢ_{₁}, rᵢ_{₁}), (cᵢ_{₂}, rᵢ_{₂}), . . .
Compute the total coverage as:

$${R}_{N} = {\sum }_{n = 1}^{N} {r}_{{i}_{n}}$$

Determine, given an input parameter 0<θ<1 denoting the coverage target, the number N* such that R_{N*}≥θ and R_{N*-1}<θ, and construct the set C={cᵢ_{₁}, cᵢ_{₂} . . . , cᵢ_{_{N*}}}
Alternatively, N* is an input parameter; the parameter θ or the parameter N* are chosen to trade off BSSID coverage for scan time and power consumption
Step 1325: Schedule full scan alarm after T_{Fast}, then proceeds to Step 1335
Step 1330: Perform partial scan of channels C
Step 1335: Issue a request to scan channels C after T_{P}_{₁}

As illustrated in FIG. 13B, method 1350, which is similar to method 1300, may comprise the following operations, starting at Step 1355:
Step 1355: Determine if the scan alarm corresponds to a full scan or to a partial scan; in the case of a full scan alarm proceed to Step 1360; otherwise, proceed to Step 1380
Step 1360: Issue request for full scan and wait to receive scan results
Step 1365: Add every BSSID appearing in the scan results into the set Bᵢ that matches corresponding channel cᵢ
Step 1370: Determines the set C of most used channels as follows:
   Compute the coverage {rᵢ} of every channel i, i.e., the ratio of BSSIDs operating on channel i to all BSSIDs, as a function of the sizes of the BSSID sets {|Bⱼ|} for every channel j. This is represented by the equation below:

$${r}_{i} = \frac{\vert {B}_{i} \vert}{{\sum }_{j} \vert {B}_{j} \vert}$$

Sort the dictionary, i.e., channel-coverage pairs {(cᵢ, brᵢ)} in decreasing order of coverage, yielding (cᵢ_{₁}, rᵢ_{₁}), (cᵢ_{₂}, rᵢ_{₂}), . . .
Compute the total coverage as:

$${R}_{N} = {\sum }_{n = 1}^{N} {r}_{{i}_{n}}$$

Determine, given an input parameter 0<θ<1 denoting the coverage target, the number N* such that R_{N*}≥θ and R_{N*-1}<θ, and construct the set C={cᵢ_{₁}, cᵢ_{₂}, . . . , cᵢ_{_{N*}}}
Alternatively, N* is an input parameter; the parameter θ or the parameter N* are chosen to trade off BSSID coverage for scan time and power consumption
Step 1375: Schedule full scan alarm after T_{Slow}, then proceeds to Step 1385
Step 1380: Perform partial scan of channels C
Step 1385: Issue a request to scan channels C after T_{P}_{₂}

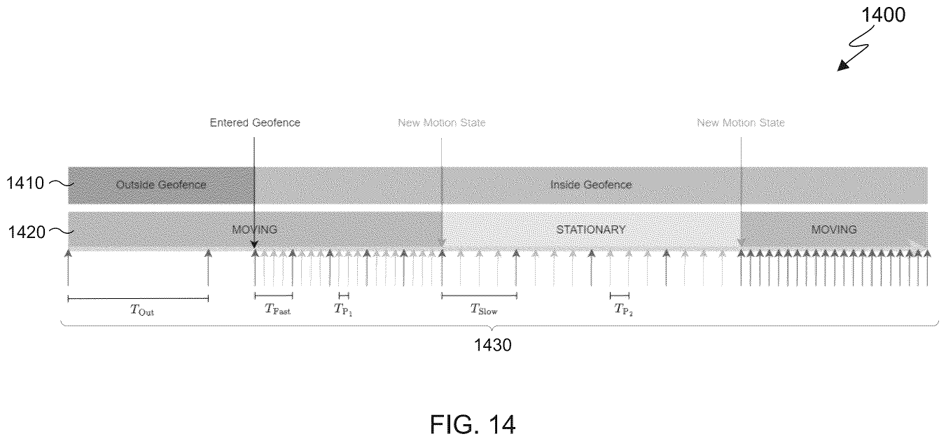

FIG. 14 illustrates an example timing diagram 1400 associated with a state machine according to embodiments of the present disclosure. More particularly, timing diagram 1400 illustrates an example scan schedule determined under state machine 1200 in response to changes in the state of motion of the device and the entering of the device into a geofence. This example is for illustration only and other embodiments can be used without departing from the scope of the present disclosure.

As illustrated in FIG. 14, timing diagram 1400 may comprise an upper block 1410 and a lower block 1420, where upper block 1410 represents the time frame in which the device is outside or inside the geofence and lower block 1420 represents the time frame in which the device is moving or stationary. Furthermore, arrows 1430 may represent the scan requests issued/scheduled by the device, with the darker arrows representing full scan request and the lighter arrows representing partial scan request and the spaces between the arrows representing the various scan intervals.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method comprising:
detecting whether an event has occurred for a device, wherein the event is based on a motion state of the device relative to a geofence;
identifying characteristics associated with the event;
determining one or more times to schedule a scan request based on the characteristics associated with the event;
scheduling the scan request at the one or more determined times; and
performing the scan request scheduled at the one or more determined times.

2. The method of claim 1, wherein:
identifying characteristics associated with the event comprises:
detecting that the device has entered the geofence, and
determining whether the motion state of the device is moving or stationary; and
determining the one or more times to schedule the scan request comprises determining to schedule the scan request more quickly when the device has entered the geofence and is moving than when the device has entered the geofence and is stationary.

3. The method of claim 1, wherein:
identifying characteristics associated with the event comprises:
detecting that the device has entered the geofence,
determining whether the motion state of the device is moving or stationary, and
determining whether a predetermined layover time has expired;
determining the one or more times to schedule the scan request comprises determining to schedule the scan request more quickly when the device has entered the geofence and the predetermined layover time has not expired than when the device has entered the geofence and the predetermined layover time has expired; and
after the predetermined layover time has expired, determining the one or more times to schedule the scan request further comprises determining to schedule the scan request more quickly when the device is moving inside the geofence than when the device is stationary inside the geofence.

4. The method of claim 3, wherein determining the one or more times to schedule the scan request further comprises determining to schedule the scan request in bursts when the device is stationary inside the geofence.

5. The method of claim 1, wherein:
identifying characteristics associated with the event comprises detecting that the device has exited the geofence; and
determining the one or more times to schedule the scan request comprises determining to schedule the scan request more slowly when the device has exited the geofence than when the device is moving or stationary inside the geofence.

6. The method of claim 1, wherein:
identifying characteristics associated with the event comprises determining whether the motion state of the device is moving or stationary inside the geofence; and
determining the one or more times to schedule the scan request comprises determining to schedule the scan request more quickly when the device is moving inside the geofence than when the device is stationary inside the geofence.

7. The method of claim 6, wherein determining the one or more times to schedule the scan request further comprises determining to schedule the scan request in bursts when the device is stationary inside the geofence.

8. The method of claim 1, wherein:
identifying characteristics associated with the event comprises:
determining whether the motion state of the device is moving or stationary inside the geofence, and
determining whether a predetermined layover time has expired; and
determining the one or more times to schedule the scan request comprises determining to schedule the scan request more quickly when the device becomes stationary inside the geofence and the predetermined layover time has not expired than when the device is stationary inside the geofence and the predetermined layover time has expired.

9. The method of claim 1, wherein:
identifying characteristics associated with the event comprises determining whether the motion state of the device is moving or stationary inside the geofence; and
determining the one or more times to schedule the scan request comprises performing a first routine when the device is moving inside the geofence, the first routine comprising:
determining whether a current scan request is a full scan type or a partial scan type,
wherein when the current scan request is determined to be the full scan type, the first routine further comprises:
performing the current scan request that initiates a full scan of all supported channels;
storing basic service set identifiers (BSSIDs) received and the supported channel corresponding to each BSSID;
determining a subset of the supported channels that are most used based on the BSSIDs received;
determining to schedule the scan request more quickly when the device is moving inside the geofence than when the device is stationary inside the geofence, wherein the scan request is the full scan type; and
determining to schedule a partial scan request more quickly than when the scan request is scheduled, wherein the partial scan request initiates a partial scan of the subset of the supported channels,
wherein when the current scan request is determined to be the partial scan type, the first routine further comprises:
performing the current scan request that initiates the partial scan of the subset of the supported channels; and
determining to schedule the partial scan request more quickly than the scan request.

10. The method of claim 1, wherein:
identifying characteristics associated with the event comprises determining whether the motion state of the device is moving or stationary inside the geofence; and
determining the one or more times to schedule the scan request further comprises performing a second routine when the device is stationary inside the geofence, the second routine comprising:
determining whether a current scan request is a full scan type or a partial scan type,
wherein when the current scan request is determined to be the full scan type, the second routine further comprises:
performing the current scan request that initiates a full scan of all supported channels;
storing BSSIDs received and the supported channel corresponding to each BSSID;
determining a subset of the supported channels that are most used based on the BSSIDs received;
determining to schedule the scan request more slowly when the device is stationary inside the geofence than when the device is moving inside the geofence, wherein the scan request is of the full scan type; and
determining to schedule a partial scan request more quickly than the scan request, wherein the partial scan request initiates a partial scan of the subset of the supported channels,
wherein when the current scan request is determined to be the partial scan type, the second routine further comprises:
performing the current scan request that initiates the partial scan of the subset of the supported channels; and
determining to schedule the partial scan request more quickly than the scan request.

11. A device comprising:
a transceiver; and
a processor operably coupled to the transceiver, configured to:
detect whether an event has occurred for the device, wherein the event is based on a motion state of the device relative to a geofence;
identify characteristics associated with the event;
determine one or more times to schedule a scan request based on the characteristics associated with the event;
schedule the scan request at the one or more determined times; and
perform the scan request scheduled at the one or more determined times.

12. The device of claim 11, wherein:
to identify characteristics associated with the event, the processor is further configured to:
detect that the device has entered the geofence, and
determine whether the motion state of the device is moving or stationary; and
to determine the one or more times to schedule the scan request, the processor is further configured to determine to schedule the scan request more quickly when the device has entered the geofence and is moving than when the device has entered the geofence and is stationary.

13. The device of claim 11, wherein:
to identify characteristics associated with the event, the processor is further configured to:
detect that the device has entered the geofence,
determine whether the motion state of the device is moving or stationary, and
determine whether a predetermined layover time has expired;
to determine the one or more times to schedule the scan request, the processor is further configured to determine to schedule the scan request more quickly when the device has entered the geofence and the predetermined layover time has not expired than when the device has entered the geofence and the predetermined layover time has expired; and
after the predetermined layover time has expired, to determine the one or more times to schedule the scan request, the processor is further configured to determine to schedule the scan request more quickly when the device is moving inside the geofence than when the device is stationary inside the geofence.

14. The device of claim 13, wherein to determine the one or more times to schedule the scan request, the processor is further configured to determine to schedule the scan request in bursts when the device is stationary inside the geofence.

15. The device of claim 11, wherein:
to identify characteristics associated with the event, the processor is further configured to detect that the device has exited the geofence; and
to determine the one or more times to schedule the scan request, the processor is further configured to determine to schedule the scan request more slowly when the device has exited the geofence than when the device is moving or stationary inside the geofence.

16. The device of claim 11, wherein:
to identify characteristics associated with the event, the processor is further configured to determine whether the motion state of the device is moving or stationary inside the geofence; and
to determine the one or more times to schedule the scan request, the processor is further configured to determine to schedule the scan request more quickly when the device is moving inside the geofence than when the device is stationary inside the geofence.

17. The device of claim 16, wherein to determine the one or more times to schedule the scan request, the processor is further configured to determine to schedule the scan request in bursts when the device is stationary inside the geofence.

18. The device of claim 11, wherein:
to identify characteristics associated with the event, the processor is further configured to:
determine whether the motion state of the device is moving or stationary inside the geofence, and
determine whether a predetermined layover time has expired; and
to determine the one or more times to schedule the scan request, the processor is further configured to determine to schedule the scan request more quickly when the device becomes stationary inside the geofence and the predetermined layover time has not expired than when the device is stationary inside the geofence and the predetermined layover time has expired.

19. The device of claim 11, wherein:
to identify characteristics associated with the event, the processor is further configured to determine whether the motion state of the device is moving or stationary inside the geofence; and
to determine the one or more times to schedule the scan request, the processor is further configured to perform a first routine when the device is moving inside the geofence, wherein to perform the first routine, the processor is further configured to:
determine whether a current scan request is a full scan type or a partial scan type,
wherein when the current scan request is determined to be the full scan type, the processor is further configured to:
perform the current scan request that initiates a full scan of all supported channels;
store basic service set identifiers (BSSIDs) received and the supported channel corresponding to each BSSID;
determine a subset of the supported channels that are most used based on the BSSIDs received;
determine to schedule the scan request more quickly when the device is moving inside the geofence than when the device is stationary inside the geofence, wherein the scan request is the full scan type; and
determine to schedule a partial scan request more quickly than when the scan request is scheduled, wherein the partial scan request initiates a partial scan of the subset of the supported channels,
wherein when the current scan request is determined to be the partial scan type, the processor is further configured to:
perform the current scan request that initiates the partial scan of the subset of the supported channels; and
determine to schedule the partial scan request more quickly than the scan request.

20. The device of claim 11, wherein:
to identify characteristics associated with the event, the processor is further configured to determine whether the motion state of the device is moving or stationary inside the geofence; and
to determine the one or more times to schedule the scan request, the processor is further configured to perform a second routine when the device is stationary inside the geofence, wherein to perform the second routine, the processor is further configured to:
determine whether a current scan request is a full scan type or a partial scan type,
wherein when the current scan request is determined to be the full scan type, the processor is further configured to:
perform the current scan request that initiates a full scan of all supported channels;
store BSSIDs received and the supported channel corresponding to each BSSID;
determine a subset of the supported channels that are most used based on the BSSIDs received;
determine to schedule the scan request more slowly when the device is stationary inside the geofence than when the device is moving inside the geofence, wherein the scan request is of the full scan type; and
determine to schedule a partial scan request more quickly than the scan request, wherein the partial scan request initiates a partial scan of the subset of the supported channels,
wherein when the current scan request is determined to be the partial scan type, the processor is further configured to:
perform the current scan request that initiates the partial scan of the subset of the supported channels; and
determine to schedule the partial scan request more quickly than the scan request.
